(19) United States
(12) Patent Application Publication
(10) Pub. No.: US 2011/0302050 A1
(43) Pub. Date: Dec. 8, 2011

(54) SMART PHONE PROBE AND APPLICATION FOR SKI WAX RECOMMENDATION

(76) Inventor: Michael Rogler Kildevaeld, Yarmouthport, MA (US)

(21) Appl. No.: 13/154,297

(22) Filed: Jun. 6, 2011

Related U.S. Application Data
(60) Provisional application No. 61/351,489, filed on Jun. 4, 2010.

(51) Int. Cl. G06Q 30/00

(52) U.S. Cl. 705/26.7

(57) ABSTRACT

The system may include a multi-function probe, a recommendation engine, a transaction engine, a user interface, a third-party interface, and a social network portal. The multi-function probe may be configured to connect to a smartphone through a wired or wireless (e.g. BLUETOOTH) connection for sensing one or more of air temperature, snow temperature, humidity, salinity, and the like. Further, the recommendation engine may receive input about snow and weather conditions and may provide a recommendation for a ski wax, and the like. The recommendation engine may also (i) receive input including user input, (ii) examine a database of ski wax offerings, and (iii) make a ski wax recommendation based at least in part on the input and other information that may be accessible in a ski wax offering database.

### CROSS-REFERENCE TO RELATED APPLICATIONS

This application claims the benefit of provisional application U.S. Ser. No 61/351,489 filed Jun. 4, 2010 which is hereby incorporated by reference in its entirety.

### BACKGROUND

1. Field

The present invention relates to the use of a multi-purpose environmental sensor probe with a smart phone (e.g. IPHONE™) for making various recommendations, such as a recommendation for a selection of snow-ski wax based on temperature and other factors.

2. Description of the Related Art

Smart phones provide various capabilities for determining weather conditions and temperature of a particular location based on a regional weather forecast from a weather service, and the like. However, determining conditions locally, such as the current temperature, humidity, and the like are generally not readily available to be accessed by a smart phone except through such weather service. Also, local conditions may include detecting a temperature of an object other than the air (e.g. water, snow, and the like). Yet smart phones are ubiquitous and include superior processing and memory capabilities that are sufficient to perform detection and analysis of local temperatures and the like. Smart phone users want to make use of their phones for a wide variety of purposes including detecting a local temperature and its impact on various activities. Smart phones also include interfaces that allow for the connection of external devices (e.g. connection to a computer). Such external devices may facilitate improved utility and benefit of today's smart phone by providing capabilities not present in the smart phone (e.g. air temp, water/snow temp, humidity, salinity, and the like). Yet such capabilities were not available prior to the description of the methods and systems described herein and in the above referenced provisional to which this patent application claims benefit.

Skiing is a recreational activity using skis as equipment for traveling over snow. There are many different forms of skiing, such as alpine skiing, freestyle skiing, Nordic skiing, and the like. In addition, skiers of different ages and abilities have different needs for equipment type, configuration, upkeep, and use. These different forms of skiing and user abilities and objectives require specially designed skies as per the needs of skiers. The skis endure wear and tear on being used for long time, such as the skis may become rough due to scratches caused on the skis from ice patches or carving turns. Further, the skis may become dried out when sitting in storage during the non-skiing season. Therefore, to prevent wear and tear of the skis, ski waxes are used.

The ski waxes protect a base of the skis. Waxing the skis increases moisture and provides smoother and faster rides to the skiers. Further, there are different types of waxes available for the different types of skis and ski conditions. The type of ski wax that may be used by a skier depends, for example on the general temperature and humidity of the snow. A large variety of ski waxes are available. However, at times it may be inconvenient for a skier, such as a beginner, to select a ski wax from a store without knowing conditions that are specific to a ski slope.

In such cases, the skiers may seek recommendations about the ski waxes from their friends, other skiers, and the like. The skiers may also wish to check past snow conditions of a skiing destination. Further, the skiers may wish to know about additional tools that they may require for maintenance of their skis, accessories required while skiing at the skiing destination, and the like. However, it may be inconvenient for the skiers to get all the required information easily, particularly local conditions, etc.

In view of the limitations discussed above, there exists a need for a system that may be capable of overcoming these limitations, offer a skier some independence from the limits of ski wax retail distribution, provide a forum for providing and accessing information about ski conditions, wax use, and the like.

### SUMMARY

In an aspect of the present invention, a system capable of overcoming the above mentioned limitations is provided. The system may include a multi-function probe, a recommendation engine, a transaction engine, a user interface, a third-party interface, and a social network portal. The multi-function probe may be configured to connect to a smart phone through a wired or wireless (e.g. BLUETOOTH) connection for sensing one or more of air temperature, snow temperature, humidity, salinity, and the like. Further, the recommendation engine may receive input about snow and weather conditions and may provide a recommendation for a ski wax, and the like. The recommendation engine may also (i) receive input including user input, (ii) examine a database of ski wax offerings, and (iii) make a wax use recommendation based at least in part on the input and other information that may be accessible in a ski wax offering database.

The transaction engine of the system may facilitate purchase of items based on the recommendation (e.g. a ski wax as recommended by the recommendation engine). Further, the user interface may facilitate providing user generated and other third party data to the system. The user interface may also be used for viewing and listening to information accessible to the engine that may include user data, recommendation data, probe data, transaction data, social network data, and the like. Furthermore, the third-party interface may exchange information with the system that may be pertinent to a third-party that may include weather forecasts, wax performance specifications, historical snow conditions, clock/calendar features, and the like. In addition, the social network portal may facilitate exchange of information regarding the system, wax, conditions, results, plans, sponsors, questions, recommendations, and the like.

In another aspect of the invention, a multi-function probe may be provided. The multi-purpose probe may include a first end portion and a second end portion. The first end portion may be configured to connect to a hand-held device such as a smartphone. Further, the second end portion may be connected to the first end portion through a cable. The second end portion may be configured with a plurality of sensors for detecting various weather conditions. In addition, the multi-function probe may be capable of detecting various weather conditions such as temperature, humidity, salinity, and the like. In an embodiment, the multi-function probe may be connected with the smartphone. Further, a recommendation engine of the smartphone may provide recommendations based on the weather conditions.

In another aspect of the invention, communication between a third-party interface and a recommendation facility of a smartphone may be provided. The third-party interface may be capable of providing third party data to a smartphone. In an embodiment, the third-party data may include at least one of weather forecasts, clock/calendar features, historical weather conditions, and the like. Further, the third-party interface may communicate with a smartphone such that a recommendation engine of the smartphone may provide recommendations based on the data received from the third-party interface.

In another aspect of the invention, communication between a social network portal and a recommendation engine of a smartphone is provided. The social network portal may be capable of facilitating exchange of information between users. Further, the recommendation engine of the smartphone may provide recommendations based on the data received from the social network portal.

In an aspect of the invention, communication between a transaction engine and a user is provided. The communication may be based on a user's decision to purchase an item recommended by a recommendation engine of a smartphone. Further, the transaction engine may connect to a payment gateway of a banking institution.

In another aspect of the invention, a recommendation facility is provided. The recommendation facility may include a data transformation facility and a recommendation engine. The data transformation facility may be capable of converting data of any format into a data that may be compatible with the smartphone. Further, the data transformation facility may receive data from a plurality of external sources and devices. The recommendation engine may provide recommendations on the basis of the data received by the data transformation facility.

### BRIEF DESCRIPTION OF THE FIGURES

The invention and the following detailed description of certain embodiments thereof may be understood with reference to the following figures:

FIG. 1 depicts a smart phone in communication with an external device and a plurality of external sources, in accordance with an embodiment of the present invention;

FIG. 2 depicts a front view of the smartphone and the multi-function probe, in accordance with an embodiment of the present invention;

FIGS. 3A-3G depict various perspective views of a thermometer with a display, in accordance with an embodiment of the present invention;

FIGS. 4A & 4B depict temperature and other parameters sensed by the multi-function probe, displayed on a user interface of the smart phone, in accordance with an embodiment of the present invention;

FIG. 5 depicts display of data received from the third-party interface on the smart phone, in accordance with an embodiment of the present invention;

FIG. 6 depicts recommendations made by a recommendation engine of a recommendation facility installed in a smartphone, in accordance with an embodiment of the present invention;

FIG. 7 depicts a video shared by the social network portal being displayed on the user interface, in accordance with an embodiment of the present invention; and

FIG. 8 depicts a user interface for purchasing an item recommended by the recommendation engine, the item being purchased through the purchase engine, in accordance with an embodiment of the present invention.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather to provide an understandable description of the invention.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and not necessarily mechanically.

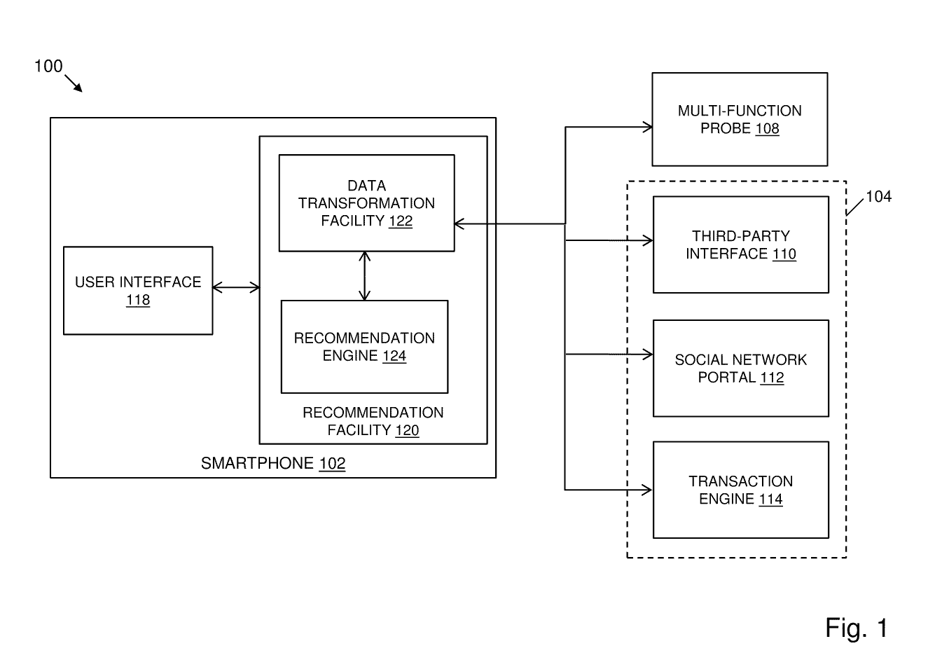

Referring now to FIG. 1, which depicts smart-phone based sensing and recommendation facility that may include a hand-held device such as a smartphone 102 in communication with a plurality of external sources and external devices such as a multi-function probe 108 (hereinafter referred as probe 108). The plurality of external sources may include a third-party interface 110, a social network portal 112, a user interface associated with the smartphone, a transaction engine 114, and various smart-phone and server applications, databases, software, wired and wireless interfaces, and the like. Examples of the hand-held device may include, but are not limited to, an IPHONE™, an IPAD™, and the like. The smartphone 102 may include a user interface 118 and various applications such as a recommendation facility 120. In an embodiment, the user interface 114 may be a touch interface. In another embodiment, the user interface 114 may employ external buttons of the smartphone 102 and or on the probe 108. The user may access the recommendation facility 120 through the user interface 104. For example, the user may need to provide identification information such as a login id and a password for accessing the recommendation facility 120. In an embodiment, the recommendation facility 120 may be integrated with the smartphone 102. In another embodiment, the recommendation facility 120 may be downloadable from an application store. Portions of the recommendation facility 120 may execute on the hand-held device 102, on a server, on the probe 108, and the like. Further, the recommendation facility 120 may include a data transformation facility 122 and a recommendation engine 124.

The data transformation facility 122 may convert the data received by the recommendation facility 120 in a format that may be compatible with the recommendation engine 124. The recommendation engine 124 may accordingly provide recommendations to a user, on the basis of the data received by the data transformation facility 122. For example, the probe 108 may include sensors for detecting various parameters such as temperature, humidity, salinity, and the like. The sensors may transmit signals to the recommendation facility 120. Thereafter, the data transformation facility 122 may convert the signals into a format that may be compatible with the recommendation engine 124. In embodiments, the recommendation engine 124 may employ a recommendation algorithm for providing recommendations to the user based on a temperature data, such as the places the user may visit, the kind of clothes and accessories the user may carry along, and the like. Considering a skiing scenario, the recommendation engine 124 may receive inputs from the data transformation facility 122 such as temperature of snow. Thereafter, the recommendation engine 124 may examine a database of ski wax offerings and may recommend a ski wax based on the inputs and information in the database about the ski wax. The recommendations may be received by the user as an audio, video, or multimedia content. The user may access such content through the user interface 118 of the smartphone 102.

In an exemplary embodiment, the probe 108 may be used for measuring temperature at a beach. Based on the air and water temperature readings, water salinity detection and the like of the probe 108, the recommendation engine 124 of the smartphone 102 may recommend a sunscreen to a user.

In an embodiment, the recommendation facility 120 may provide recommendations on the basis of data received from the probe 108. For example, the probe 108 and the recommendation facility 120 may provide recommendations related to a sports activity such as skiing.

The probe 108 may include a first end portion and a second end portion. The first end portion of the probe 108 may include sensors, user interface features (buttons, displays, and the like), processing and communication capabilities so that the probe 108 can be in communication with the smartphone 102. The second end portion of the probe 108 may include sensors for detecting temperature of an item (e.g., snow, water, sand, and the like. In the example, the user may put the second end portion of the probe 108 into the snow. Accordingly, the probe 108 may transmit signals regarding the temperature readings of the snow to a nearby smart-phone 102. The data transformation facility 122 may convert the signals into a format that may be readable by the recommendation engine 124. On the basis of the temperature readings of the probe 108, the recommendation engine 124 may provide recommendations to the user. The recommendations may include types of skis that may be used, types of ski waxes, skiing accessories, and the like. In embodiments, the recommendation facility 120 of the smartphone 102 may communicate with the probe 108 via a wireless communication protocol, such as a secure, long-range Bluetooth® connection. Further details of the probe 108 will be explained in later parts of the specification.

In another embodiment, the recommendation facility 120 may provide recommendations on the basis of data received from the plurality of external sources 104. For example, the third-party interface 110 may share data about a ski wax manufactured by a European manufacturer, with the recommendation facility 120. This shared data may be in metric units as per the European system. The data transformation facility 122 may convert the European metric units in the U.S units and may then forward this converted data to the recommendation engine 124. The recommendation engine 124 may recommend ski waxes as per the U.S units that may facilitate a user to easily identify the required manufacturer in the U.S. The third-party interface 110 may be used for exchange of information that may be pertinent to a third-party. The information may include, but is not limited to, weather forecasts, ski wax performance, historical snow conditions at a location, clock and calendar features.

In a scenario, users may share their experiences with each other through the social network portal 112. The social network portal 112 may facilitate the users to exchange information about the recommendation facility 120, different waxes, their plans, queries, conditions of a skiing area, sponsors of a skiing event, and the like. In an example, users may describe their experience about skiing conditions of location X. At times, the users may provide comprehensive description about the skiing conditions. In such cases, the data transformation facility 122 may identify keywords from the description and may send these keywords to the recommendation engine 124. The recommendation engine 124, in turn, may provide recommendations based on these keywords. Further, the social network portal 112 may allow users to share videos, pictures, start group chats, discussions, and the like.

The recommendation facility 120 may also facilitate a user to purchase items that the user may select from a list of the recommendations made by the recommendation engine 124. For example, the recommendation engine 124 may provide a list of ski and snowboard waxes, based on the temperature readings taken by the probe 108. The user may select a wax of interest and if the user does not have access to the wax, the transaction engine 114 may enable the user to purchase the wax from a store. The transaction engine 114 may enable the user to make payment by connecting to a secure website of a banking institution in which the user holds an account. Once the user makes a payment for the selected wax, an order may be placed in the respective store. The ordered wax may be delivered to the user on the next day of placing the order.

In embodiments, the recommendation facility 120 may enable the users to rate the products recommended by the recommendation engine 124. For example, the users may rate the products as per the usefulness of a product, timely delivery of a product, and the like. Alternatively, the recommendation engine 124 may itself rate a few products based on purchase behavior of the users. Based on the ratings provided by the users, the recommendation engine 124 may provide recommendations to other users when searched for similar products. The recommendation engine 120 may also facilitate the users, such as third party users, to provide advertisements related to the third-party data. For example, if the third-party data includes weather forecast for a location, the recommendation facility 120 may allow third-party users to display advertisements for products that may be in accordance with the weather forecast.

In an embodiment, the recommendation facility 120 may calculate temperature at a certain time of day, based on the current temperature, time, weather forecast, and the like. For example, the recommendation facility 120 may be connected to local weather channels through the third-party interface 110. The local weather channels may provide details of the weather such as how sunny a day is or will be, temperature & humidity at a particular time, rain predictions, and the like. In a scenario, if the temperature at 9 AM at a specific location is 10 degrees, the recommendation facility 120 may predict the temperature at noon. Likewise, the recommendation facility 120 may predict the temperature of snow at different times during a skiing event.

In embodiments, the recommendation facility 120 may also provide recommendations regarding information items such as books, web sites, videos, ski instructors, demo ski inventories of local ski rental shops, ski wax inventories and prices at local ski shops, ski competition levels for the skier, downhill ski speed predictions, ski slope use/demand based on GPS data and user entered data received from other smart-phone users who may participate in a social network information sharing application, and the like, based on the data received from the probe 108, the third-party interface 110, the social network portal 112, the transaction engine 114, and the user interface 118. Further, the recommendation facility 120 may provide recommendations about social elements such as people, groups, events, and the like, that may be of interest to the user. In a scenario, a user may be an amateur skier, the recommendation engine 124 of the recommendation facility 120 may recommend such user about the various groups that the user may join, list of skiing events, best-selling books, and the like, on receiving some data from the user and other sources.

In an embodiment, the recommendation facility 120 may provide recommendations based on data captured by a camera of the smartphone 102. For example, a user may click pictures of snowflakes at a skiing location. The user may magnify the camera lens by using magnification software. Alternatively, the user may hold the snowflakes in hand and may click the pictures. The user may employ magnification techniques that may be added to a camera such as via a case, a stick on, and the like. Based on the images of the snowflakes, the recommendation engine 124 may determine the wax that the user may use. For example, sharper snowflakes crystals may remove wax applied to a ski or snowboard. Accordingly, the recommendation engine 124 may recommend a colder/harder wax that may not be easily removed.

In embodiments, the recommendation facility 120 may store personal wax selections of a user as per different snow types. Also, the recommendation facility 120 may store a result set as best results for ski waxes as may be identified by the user. The recommendation facility 120 may further store best results for ski waxes from history of other users. When a user searches for a ski wax, the recommendation facility 120 may provide the user with the best results for ski waxes from the history also.

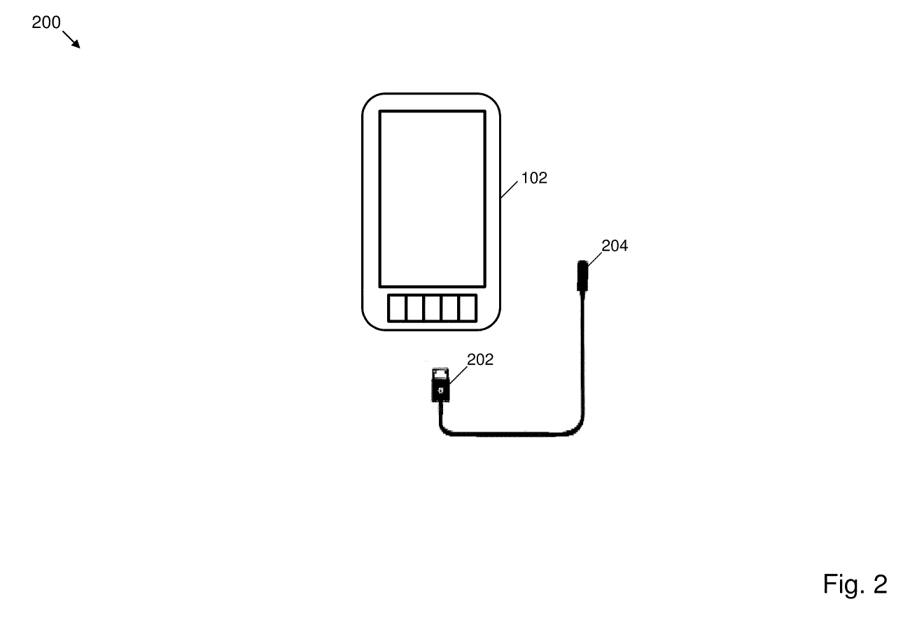

Now referring to FIG. 2, a front view 200 of a smartphone 102 and a wired version of the multi-function probe 108 have been depicted, in accordance with an embodiment of the present invention. The wired probe 200 may include a connection end portion 202 and a sensing/control end portion 204. The sensing/control end portion 204 may include sensors that may be configured to detect temperature, humidity, salinity, and the like. The connecting end portion 202 of the probe 108 may include a port that may facilitate connection through a port such as a Universal Serial Bus (USB) port of the smartphone 102. The sensing/control end portion 204, or a portion thereof may be inserted beneath the surface of the snow or into a liquid to detect temperature of the snow/liquid. The sensors may detect the temperature of the snow and based on this temperature, the recommendation engine 124 may suggest a ski wax that the user may use for the skis. The smartphone 102 may display the information sensed by the sensors of the wired probe 200 through the user interface 118.

More generally, the sensors of the probe 108 may also detect the crystal size, crystal shape, hardness, humidity, UV radiation, salinity, and the like. Alternatively, the information collected by the probe may be analyzed, along with other information such as historical data, and the like to determine aspects of snow such as crystal size, shape, hardness, and the like. Further, the probe 108 may be used as a measuring device for testing temperature of a baby bottle, testing temperature of a baby's bath water, detecting temperature of food being cooked, and the like. Further, the probe 108 may be used for measuring density of soil at a particular region. The temperature read by the probe 108 sensors may be displayed on a display screen of the smartphone 102. In an embodiment, the smartphone 102 may be connected to a thermometer.

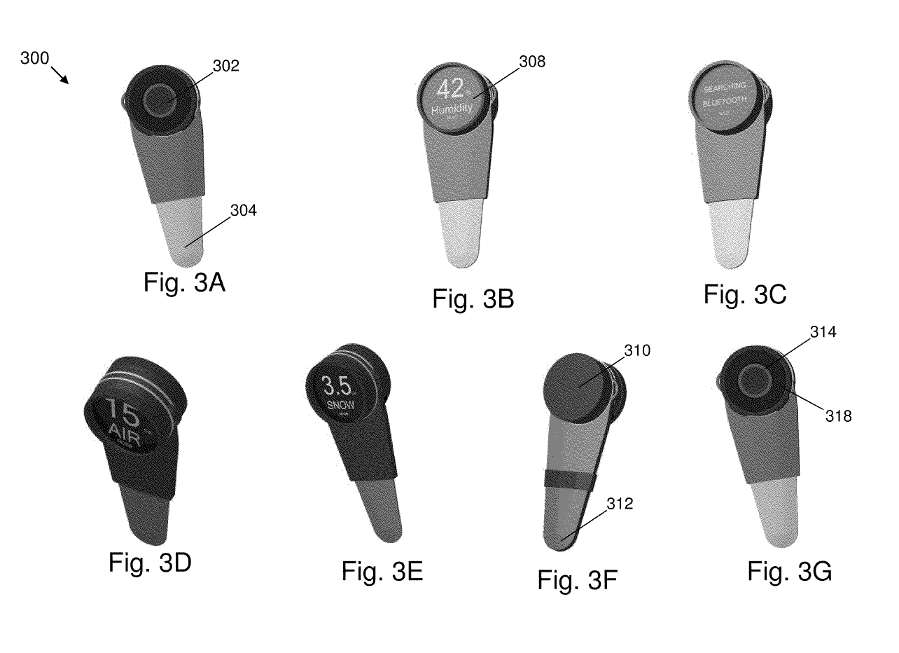

Referring to FIGS. 3A-3F, various views of a wireless probe 300 are depicted, in accordance with an embodiment of the present invention. The wireless probe 300 may be rigid and may be made of a strong material. The wireless probe 300 may be connectable through a wireless connection to the recommendation facility 120 executing on a smartphone 102. In an embodiment, the connection between the wireless probe 300 and the recommendation facility 120 may include, but is not limited to, a Bluetooth connection, WiFi, and the like. The wireless probe 300 may measure information regarding temperature of snow, air, humidity, and the like as described herein generally for probe 108.

FIG. 3A depicts a rear perspective view of the wireless probe 300. The wireless probe 300 may include a power button 302 for operating the wireless probe 300. A user may switch on the wireless probe 300 by pressing the push button 302. Further, the wireless probe 300 may include a tail portion 304 that may be inserted inside a surface such as snow, soil, water, and the like. Accordingly, the tail portion 304 may be strong enough and may have a sharp end so that the tail portion 304 may be conveniently inserted in the above mentioned surfaces.

FIGS. 3B-3E depict a front perspective view of the wireless probe 300. The wireless probe 300 may include a display 308 for presenting the measurements taken by the wireless probe 300. For example, the display 308 may show measurements of humidity, snow temperature, air temperature, and the like. The display 308 may also show the type of connection (e.g. wired or wireless) between the wireless probe 300 and the recommendation facility 120. Therefore, the wireless probe 300 may not require an external display for presenting the measurement data.

FIG. 3F depicts another front perspective view of the wireless probe 300, in accordance with an embodiment of the present invention. The wireless probe 300 may include a pair of covers such as a cover 310 and a cover 312. The cover 310 may be placed over the display 308, when the wireless probe 300 is not in use. Similarly, the cover 312 may be placed over the tail portion 304 of the wireless probe 300, when kept aside. The covers 310 and 312 may protect the thermometer from any breakage caused due to mishandling.

FIG. 3G depicts a rear perspective view of the wireless probe 300 in accordance with an embodiment of the present invention. In this embodiment, the wireless probe 300 may include a humidity location ring 314. The humidity location ring 314 may be configured around the power button 302 of the wireless probe 300. Further, the wireless probe 300 may include an air temperature identifying ring 318.

In an embodiment, the wireless probe 300 as described herein may save the measurement data to an in-built storage. The saved data may be uploaded to the recommendation facility 120 or a computer at a later stage.

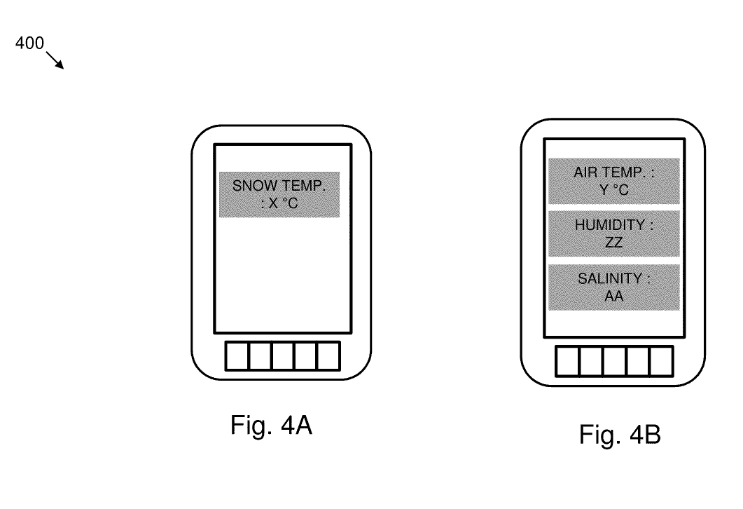

Now referring to FIGS. 4A & 4B, a front view 400 of the user interface 118 of the smartphone 102 is depicted, in accordance with an embodiment of the present invention. The user interface 118 may display temperature and other parameters sensed by the probe 108 connected to the smartphone 102. As mentioned in relation to FIG. 1, the user interface 118 may enable a user to provide input to the recommendation facility 120 as well as receive output from the recommendation facility 120.

FIG. 4A depicts the user interface 118 of the smartphone 102 displaying the snow temperature as measured by the probe 108.

FIG. 4B depicts the user interface 118 of the smartphone 102 displaying other parameters such as air temperature, humidity, and salinity as measured by the probe 108.

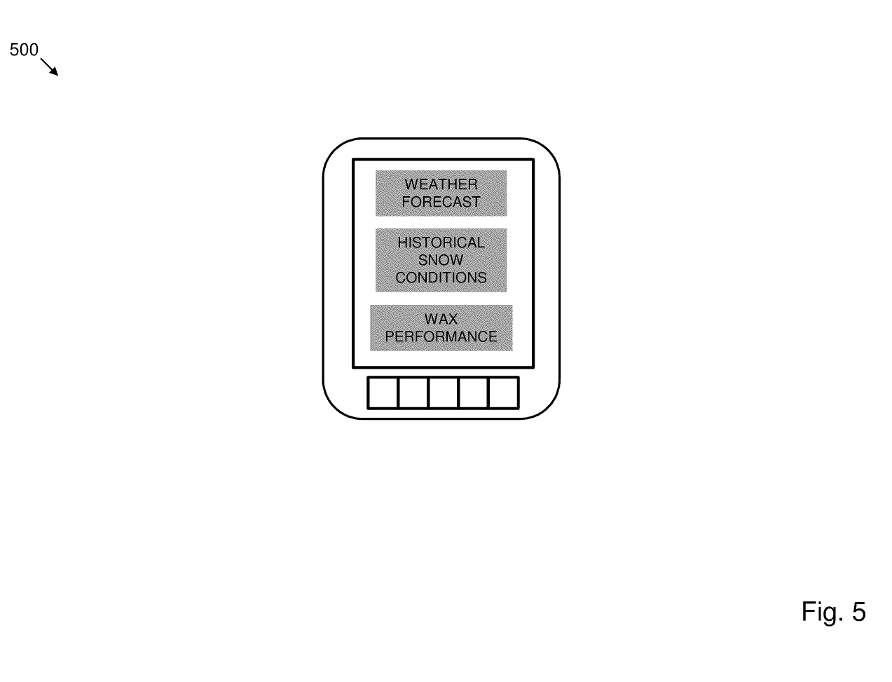

Referring to FIG. 5, a screen 500 for displaying data received from the third-party interface 110 on the smartphone 102 is depicted, in accordance with an embodiment of the present invention. The third-party interface 110 may enable exchange of data between third-party users and the recommendation facility 120. The data may be pertinent to the third-party such as weather forecasts, wax performance specifications, historical snow conditions, clock and calendar features, and the like. The third-party interface 110 may provide information collected from various third-party sources such as local metrological department, ski wax suppliers, sponsors, event organizers, and the like. For example, the third-party interface 110 may provide weather forecast about a location such as a skiing destination, so that players may decide their course.

In an embodiment, the third-party interface 110 may provide weather forecast or conditions based on location of the smartphone 102. The third-party interface 110 may identify the Global Positioning System (GPS) coordinates of the smartphone 102 and may provide local weather conditions to the smartphone 102. Further, the third-party interface 110 may also provide information about a location's historical snow conditions. Based on such information, other third-party sources such as a ski wax supplier may provide advertisements regarding products such as ski waxes, skiing accessories, and the like, that may be suitable as per the snow conditions.

In an example, the third-party sources may provide information about various skiing events that may be happening in an area. Further, the third-party interface 110 may facilitate a player to choose a suitable pair of skis, ski wax, ski accessories, and the like, by providing information about the ski stores in a location. In an embodiment, the third-party interface 110 may enable wax suppliers to promote and sell ski wax from a specific company. Further, the recommendation engine 124 may provide recommendations to users based on the data received from the third-party interface 110.

In another embodiment, the third-party interface 110 may provide test results of a wax, to the recommendation facility 120. Based on the test results also the recommendation engine 124 may provide recommendations to the user may select a ski wax recommended by the recommendation engine 124. The recommendation facility 120 may also facilitate the user to save the test results.

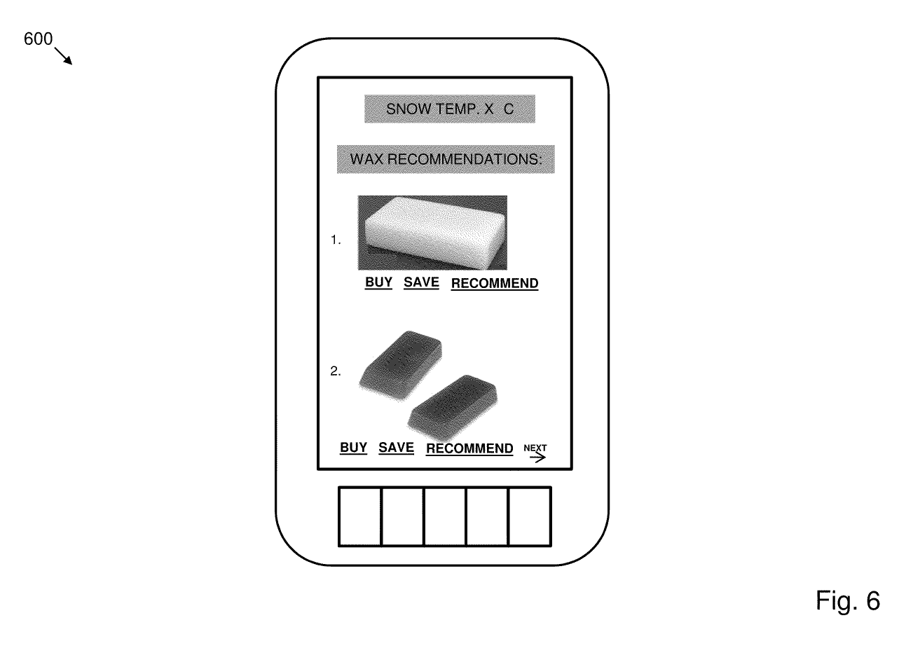

Now, referring to FIG. 6, a screen 600 of a smartphone 102 illustrating recommendations made by the recommendation engine 124 of the recommendation facility 120 is depicted, in accordance with an embodiment of the present invention. In an example, the recommendation engine 124 may provide recommendations regarding a ski wax that may be used at a particular temperature. The recommendation engine 124 may provide list of waxes in an order of relevancy. The recommendation engine 124 may provide information about the recommended wax.

The information may include images of the ski wax, names of stores/suppliers of the wax, availability status, cost, and the like. The users may check their tools for the availability of the recommended wax. The images of the wax may facilitate the users for easily identifying the wax in case the users may not be aware of the wax that the users may be carrying with them. In an embodiment, the user may save the recommended ski wax for later use. Further, the user may recommend the ski wax to another user. In case, the users do not have the recommended wax, the users may opt for buying the ski wax in case the user does not have the wax.

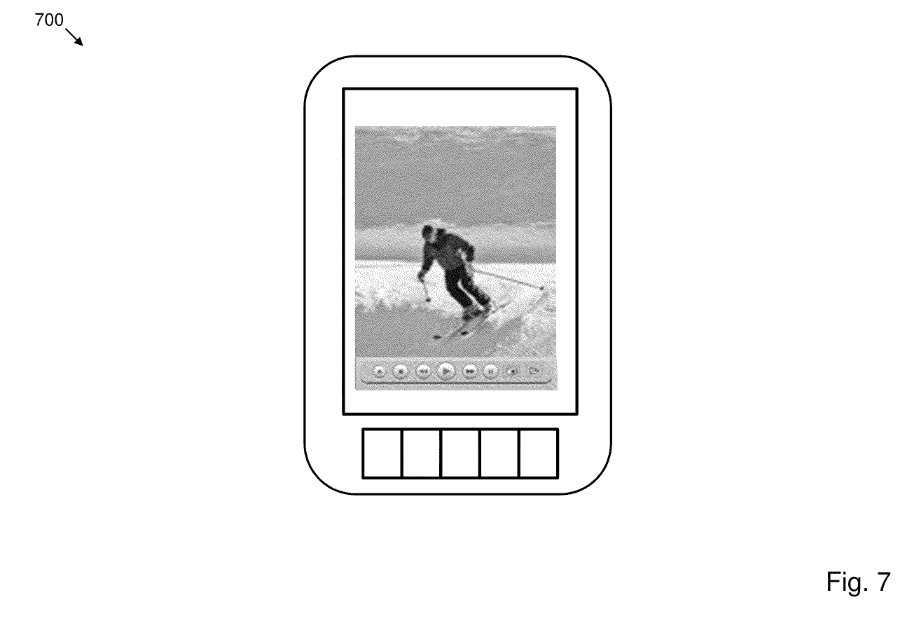

Referring to FIG. 7, a video clip 700 shared by a user through the social network portal 112 has been depicted, in accordance with an embodiment of the present invention. In embodiments, the users may interact with each other using the social network portal 112. In an embodiment, the users may start discussions on different topics, write blogs about their experiences, share content such as videos, and the like with others. For example, the users may get their skiing experience captured in pictures, videos, and the like. The user may then share such videos and pictures amongst their friends. Further, a user may view a video clip 700 of a skier on exactly the same slope where the user may be planning to go. In another example, users may get expert comments and suggestions by using the social network portal 112.

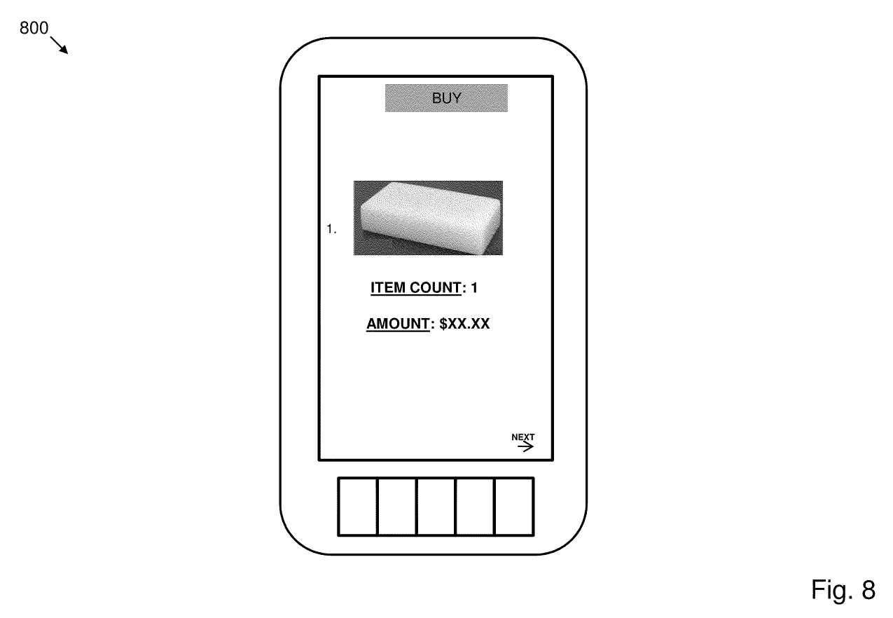

In an embodiment, the users may share their views about the types of products they have been using. Further, the users may discuss about the recent sporting activities happening in a locality, the past champions in the sporting activities, the teams participating in the sporting activities, the accessories and equipment required for the sporting activities and the like. In an exemplary embodiment, users may get views about a ski wax that may be used for a specific weather condition, effective ways of applying the ski wax, and the like. The users may also interact with experts, e.g. the users may ask questions and get advice from experts. Based on the recommendations given by the recommendation engine 124, users may decide if they want to buy a recommended product. The process of buying a recommended wax has been described in conjunction with FIG. 8.

FIG. 8 depicts the a screen 800 of a smartphone 102 illustrating a user interface 118 for purchasing a recommended ski wax, through the purchase engine 114, in accordance with an embodiment of the present invention. Once a user determines to buy a ski wax recommended by the recommendation engine 124, the recommendation engine 124 may connect to a payment gateway of a banking institution. The banking institution may be a bank where the user holds an account. Further, the payment gateway may enable a secure connection between the user and the banking institution. The user may need to provide a login Id and a password for accessing the account and may make an online payment through the purchase engine 114.

Once the payment has been made, the user may receive the purchased product such as a ski wax by next day. It may be evident to a person skilled in the art that various embodiments of the invention are explained in conjunction with skiing examples; however, the invention may also be used for providing recommendations useful for other applications.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A system, comprising:
a multi-function probe configured to connect to a smart phone through a wired connection, the probe for sensing one or more of air temperature, snow temperature, humidity, and salinity;
a ski wax recommendation engine that receives inputs regarding snow and weather conditions and other inputs including user inputs, examines a database of ski wax offerings, makes a wax use recommendation based on the inputs and information in the ski wax offering database;
a transaction engine for facilitating purchase of ski wax as recommended by the ski wax recommendation engine;
a user interface for providing user generated data to the system and for viewing / listening to information accessible to the engine including user data, recommendation data, probe data, transaction data, social network data;
a third-party interface for exchanging information with the system that is pertinent to the third-party including weather forecasts, wax performance specifications, historical snow conditions, clock/calendar features; and
a social network portal to facilitate exchange of information regarding the system, wax, conditions, results, plans, sponsors, questions, recommendations, and the like.
